(19) United States
(12) Patent Application Publication
(10) Pub. No.: US 2023/0413815 A1
(43) Pub. Date: Dec. 28, 2023

(54) SURFACE TREATMENTS UTILIZING IMMOBILIZED ANTIMICROBIAL PEPTIDE MIMICS

(71) Applicant: MAXWELL BIOSCIENCES, INC., Austin, TX (US)

(72) Inventors: King Hang Aaron LAU, Glasgow (GB); ANNELISE E. BARRON, Woodside, CA (US); JOHN FORTKORT, Austin, TX (US)

(21) Appl. No.: 18/255,468

(22) PCT Filed: Feb. 2, 2022
(86) PCT No.: PCT/US2022/014993

§ 371 Date: Jun. 1, 2023

Related U.S. Application Data
(60) Provisional application No. 63/120,686, filed on Dec. 2, 2020.

(51) Int. Cl. A01N 37/46; A01P 1/00

(52) U.S. Cl. CPC A01N 37/46; A01P 1/00

(57) ABSTRACT

A method is provided for treating a surface containing a plurality of functional groups. The method includes reacting the plurality of functional groups with a linking group, thereby creating a surface containing a plurality of linking groups; and binding a first peptoid to each of the plurality of linking groups, thereby obtaining a first treated surface.

### CROSS-REFERENCE TO RELATED APPLICATIONS

This application claims the benefit of U.S. provisional application No. 63/120,686, filed Dec. 2, 2020, having the same title, and having the same inventors, and which is incorporated herein by reference in its entirety.

### FIELD OF THE DISCLOSURE

The present disclosure relates generally to antimicrobial surface treatments, and more particularly to antimicrobial surface treatments which contain antimicrobial peptoid compositions.

### BACKGROUND OF THE DISCLOSURE

Bacterial adhesion and colonization on implantable biomedical devices and the consequent infection contribute to 40-70% of hospital-acquired infections (HAI). [J. W. Costerton, P. S. Stewart, E. P. Greenberg, Science 1999, 284, 1318-1322; E. M. Hetrick, M. H. Schoenfisch, Chem. Soc. Rev. 2006, 35, 780-789; and C. Desrousseaux, V. Sautou, S. Descamps, O. Traore, J. Hosp. Infect. 2013, 85, 87-93] Water purification systems, food packaging, and maritime operations can also be compromised by microbial contamination. [R. Chmielewski, J. Frank, Compr. Rev. Food Sci. Food Saf. 2003, 2, 22-32; X. Z. Zhao, C. J. He, ACS Appl. Mater. Interfaces 2015, 7, 17947-17953; and D. W. Wang, X. Wu, L. X. Long, X. B. Yuan, Q. H. Zhang, S. Z. Xue, S. M. Wen, C. H. Yan, J. M. Wang, W. Cong, Biofouling 2017, 33, 970-979] Despite substantial research, prevention of bacterial adhesion and growth on surfaces is still challenging. [C. D. Nadell, K. Drescher, K. R. Foster, Nat. Rev. Microbiol. 2016, 14, 589] Surface properties such as roughness and topology, chemistry and wettability, as well as surface molecular arrangements, are among the many factors that influence biofouling. [K. Bazaka, R. J. Crawford, E. P. Ivanova, Biotechnol. J. 2011, 6, 1103-1114; D. Perera-Costa, J. M. Bruque, M. L. González-Martin, A. C. Gómez-García, V. Vadillo-Rodríguez, Langmuir 2014, 30, 4633-4641; K. W. Kolewe, J. Zhu, N. R. Mako, S. S. Nonnenmann, J. D. Schiffman, ACS Appl. Mater. Interfaces 2018, 10, 2275-2281; and A. Hasan, S. K. Pattanayek, L. M. Pandey, ACS Biomater. Sci. Eng. 2018, 4, 3224-3233]

Proposed strategies for overcoming bacterial surface fouling include “antifouling” coatings that inhibit non-specific protein adsorption and bacterial attachment, such as by surface grafting poly(ethylene glycol) (PEG) as polymer brushes. [C. Blaszykowski, S. Sheikh, M. Thompson, Chem. Soc. Rev. 2012, 41, 5599-5612; A. D. White, A. K. Nowinski, W. Huang, A. J. Keefe, F. Sun, S. Jiang, Chem. Sci. 2012, 3, 3488-3494; and S. Lowe, N. M. O'Brien-Simpson, L. A. Connal, Polym. Chem. 2015, 6, 198-212] Immobilization of existing antibiotics and antibiotic-releasing coatings are other strategies. [F. Costa, I. F. Carvalho, R. C. Montelaro, P. Gomes, M. C. L. Martins, Acta Biomater. 2011, 7, 1431-1440; A. Andrea, N. Molchanova, H. Jenssen, Biomolecules 2018, 8, 27; and S. R. Palumbi, Science 2001, 293, 1786-1790] However, many existing antimicrobial agents suffer from a narrow spectrum of activity and a rising resistance against their activities. [A. Andrea, N. Molchanova, H. Jenssen, Biomolecules 2018, 8, 27; and S. R. Palumbi, Science 2001, 293, 1786-1790] Antimicrobial peptides (AMPs) are being investigated to overcome these issues [see Costa et al. and Andrea et al above], but they are degraded by proteases secreted by both human hosts and bacteria. [N. Molchanova, P. R. Hansen, H. Franzyk, Molecules 2017, 22, 1430; M. Sieprawska-Lupa, P. Mydel, K. Krawczyk, K. Wójcik, M. Puklo, B. Lupa, P. Suder, J. Silberring, M. Reed, J. Pohl, Antimicrob. Agents Chemother. 2004, 48, 4673-4679; and M. Xiao, J. Jasensky, J. Gerszberg, J. Chen, J. Tian, T. Lin, T. Lu, J. Lahann, Z. Chen, Langmuir 2018, 34, 12889-12896]

Poly(N-substituted glycine) “peptoids” represent a promising class of peptidomimics being developed to address the drawbacks of AMPs. They possess a non-natural polyglycine backbone with sidechains attached to backbone amide nitrogen atoms that offers protease resistance and enhanced lipid membrane permeability. [K. H. A. Lau, Biomater. Sci. 2014, 2, 627-633; and A. S. Knight, E. Y. Zhou, M. B. Francis, R. N. Zuckermann, Adv. Mater. 2015, 27, 5665-5691] Secondary structures are induced in specific sequences with specific sidechains. [see Knight et al. above, and M. El Yaagoubi, K. M. Tewari, K. H. A. Lau in Self-assembling Biomaterials, Elsevier-Woodhead, Amsterdam, 2018, pp. 95-112]

A number of groups have demonstrated peptoid AMP mimics that exhibit high activity. [see Andrea et al. and Malchanova et al. above. See also N. P. Chongsiriwatana, J. A. Patch, A. M. Czyzewski, M. T. Dohm, A. Ivankin, D. Gidalevitz, R. N. Zuckermann, A. E. Barron, Proc. Natl. Acad. Sci. USA 2008, 105, 2794-2799; and J. A. Patch, A. E. Barron, J. Am. Chem. Soc. 2003, 125, 12092-12093] One such peptoid has also been synthesized as part of a surface grafted peptoid brush but a high level of overall bacterial attachment was observed. [A. R. Statz, J. P. Park, N. P. Chongsiriwatana, A. E. Barron, P. B. Messersmith, Biofouling 2008, 24, 439-448] Natural AMPs such as hLf1-1, LL-37, and melamine have also been immobilized with varying results. [See Costa et al., Andrea et al. and Xiao et al. above. See also J. He, J. Chen, G. Hu, L. Wang, J. Zheng, J. Zhan, Y. Zhu, C. Zhong, X. Shi, S. Liu, J. Mater. Chem. B 2018, 6, 68-74] These studies apply bioconjugation techniques such as maleimide-thiol, amide, and alkyne-azide “click” coupling to enable covalent surface immobilization. Alkyne-azide coupling is especially suitable since it is orthogonal to reactive groups commonly found on AMPs, but the approach is often limited by the availability of specialized chemical linkers.

### SUMMARY OF THE DISCLOSURE

In one aspect, a treated surface is provided which comprises a substrate; and a first peptoid bound to said substrate by way of a linking group.

In another aspect, a method is provided for treating a surface containing a plurality of functional groups. The method comprises reacting the plurality of functional groups with a linking group, thereby creating a surface containing a plurality of linking groups; and binding a peptoid to each of the plurality of linking groups.

### BRIEF DESCRIPTION OF THE DRAWINGS

FIG. 1 depicts the chemical structures of the (kss)₄ antimicrobial sequence as well as its C- and N-modifications. B) Chemical structure of the modified sequence for CuAAC “click” coupling. The red ball representation is used in FIG. 2A.

FIG. 2 depicts the surface modification schemes for generating PEG-tethered (kss)₄ (i.e. Scheme A: GOPTS-PEG-N₃-(kss)₄) and (kss)₄ immobilized directly on the surface (i.e. Scheme B: APTMS-N₃-(kss)₄). B) Water contact angles measured after successive modification steps.

FIG. 3 are high-resolution C1s (A) and N1s (B) XPS spectra after each surface modification steps to achieve GOPTS-PEG-N₃-(kss)₄.

FIG. 4 is a series of confocal microscopy images of live (green) and dead/damaged (red) P. aeruginosa on: A) unmodified glass, B) APTMS, C) APTMS-N3-(kss)4, and D) GOPTS-PEG-N3-(kss)4; and E) Quantified attachment data corresponding to confocal measurements. Both actual coverage (q coverage) and coverage normalized to attachment on unmodified glass (qnorm) are shown; #and ##denote p<0.005 and p<0.05, respectively (one-way ANOVA).

FIG. 5 is a series of graphs depicting A) Live bacterial attachment normalized to levels on unmodified substrate (glass or Ti); and B) the ratio of dead/damaged bacterial attachment versus live attachment shown in (A). The inset shows the original dead attachment data. Open squares (&) indicate the present study for P. aeruginosa. Other symbols indicate literature data for P. aeruginosa (&), E. coli (*), S. aureus (\hat{ }), L. salivarius (˜), and S. sanguinis (*). Attachment was measured by either imaging-stained cells or re-culturing of attached bacteria.

FIG. 6 is a graph of the ratio of dead/damaged bacteria to live attachments as a function of antimicrobial peptoid (AMP) separation.

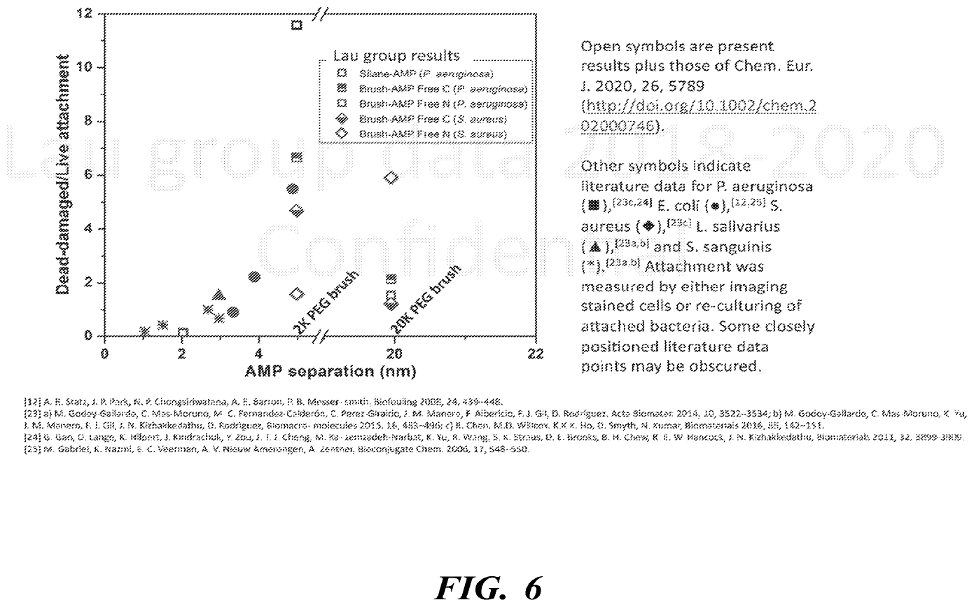

FIG. 7 is a series of graphs of (A) normalized live attachment as a function of AMP separation, and (B) normalized dead attachment as a function of AMP separation.

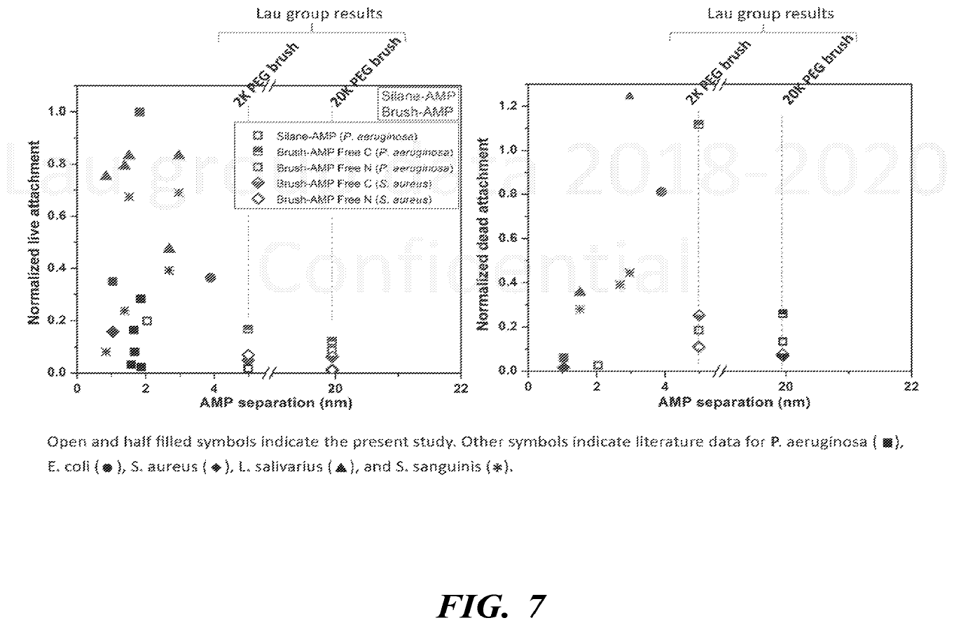

FIG. 8 is a series of graphs of normalized surface coverage of peptoids for different surfaces and showing the relative amounts of dead/damaged bacteria (P. aeruginosa) to live attachments for tethers of (A) 2k PEG, and (B) 20k PEG.

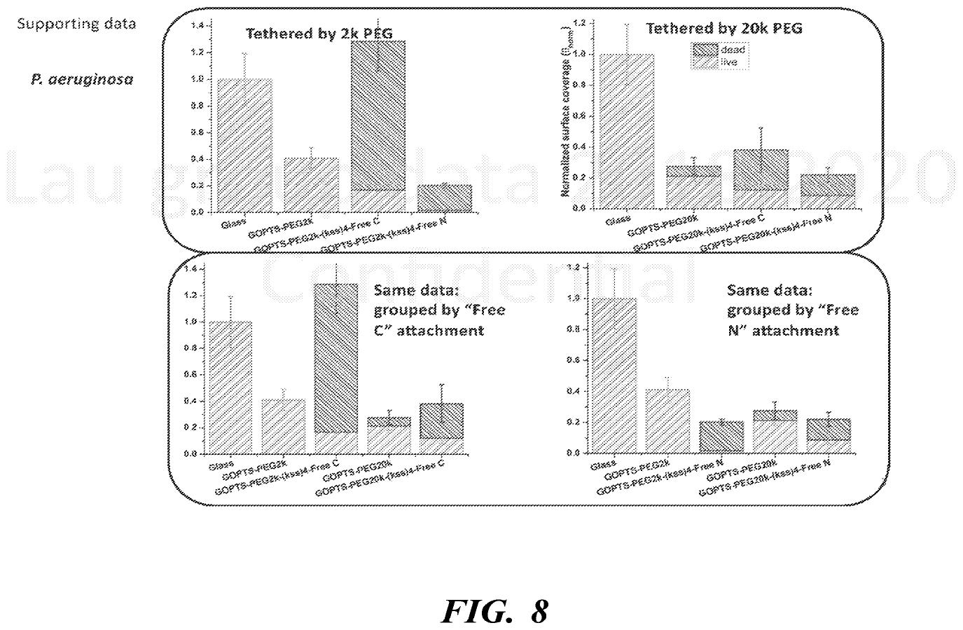

FIG. 9 is a series of graphs of normalized surface coverage of peptoids for different surfaces and showing the relative amounts of dead/damaged bacteria (S. aureus) to live attachments for tethers of (A) 2k PEG, and (B) 20k PEG.

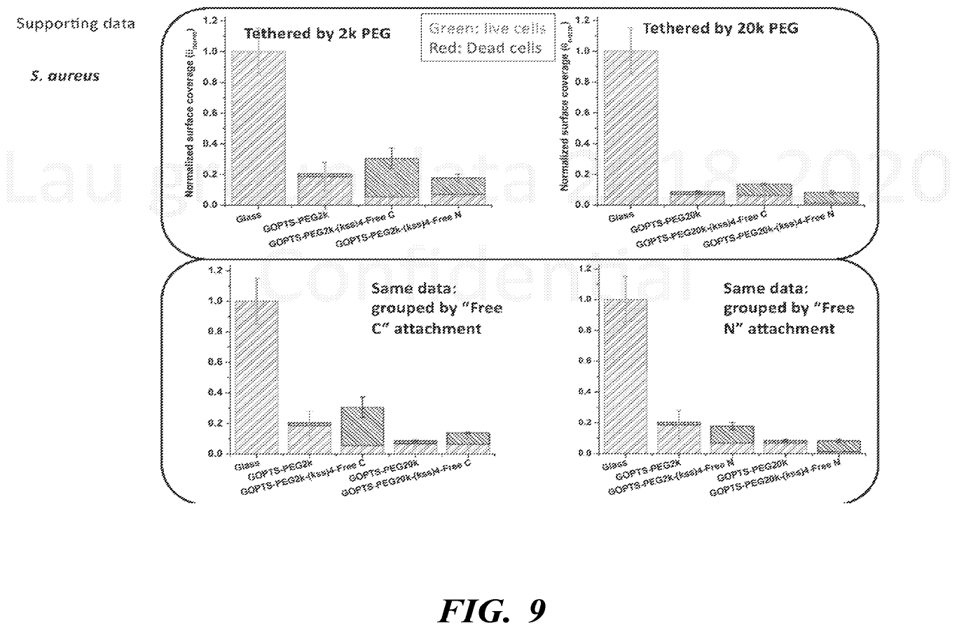

FIG. 10 is a graph of normalized surface coverage of peptoids for different surfaces and showing the relative amounts of dead/damaged bacteria (P. aeruginosa) to live attachments.

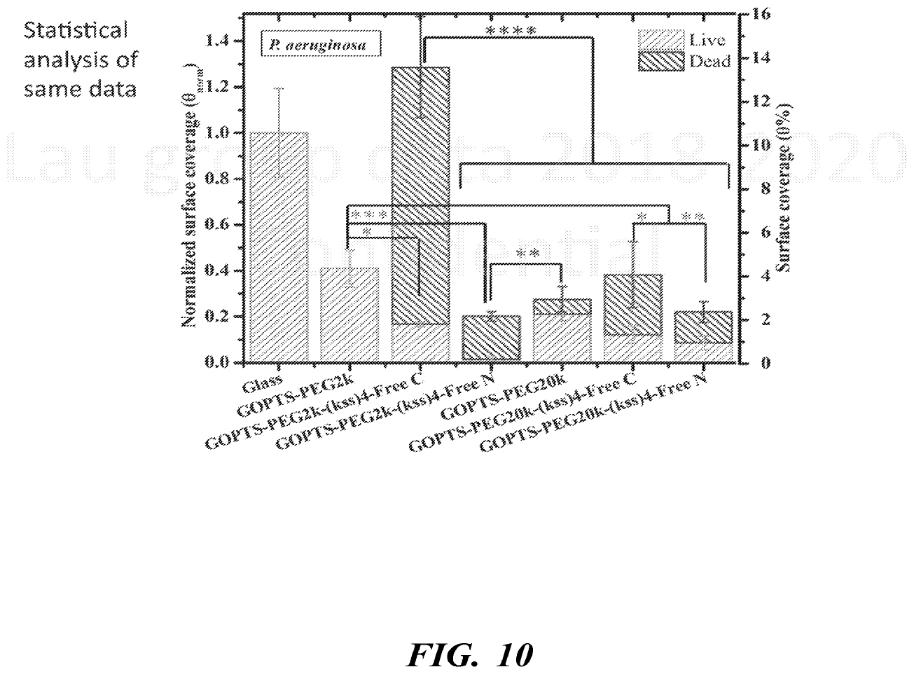

FIG. 11 is a graph of normalized surface coverage of peptoids for different surfaces and showing the relative amounts of dead/damaged bacteria (S. aureus) to live attachments.

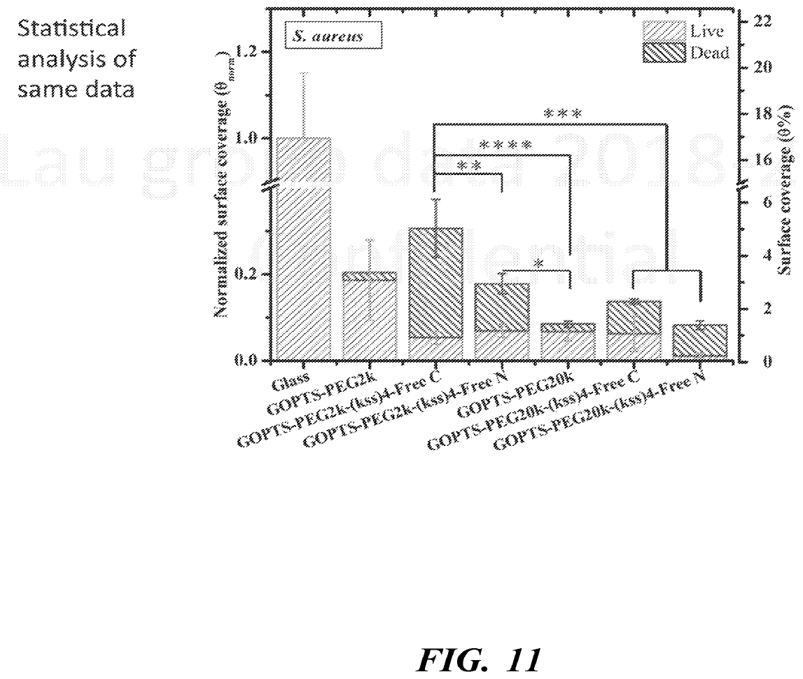

FIG. 12 is a series of micrographs showing live/dead bacteria count for an unmodified surface compared to the same surface modified with various tethered AMPs of the type disclosed herein.

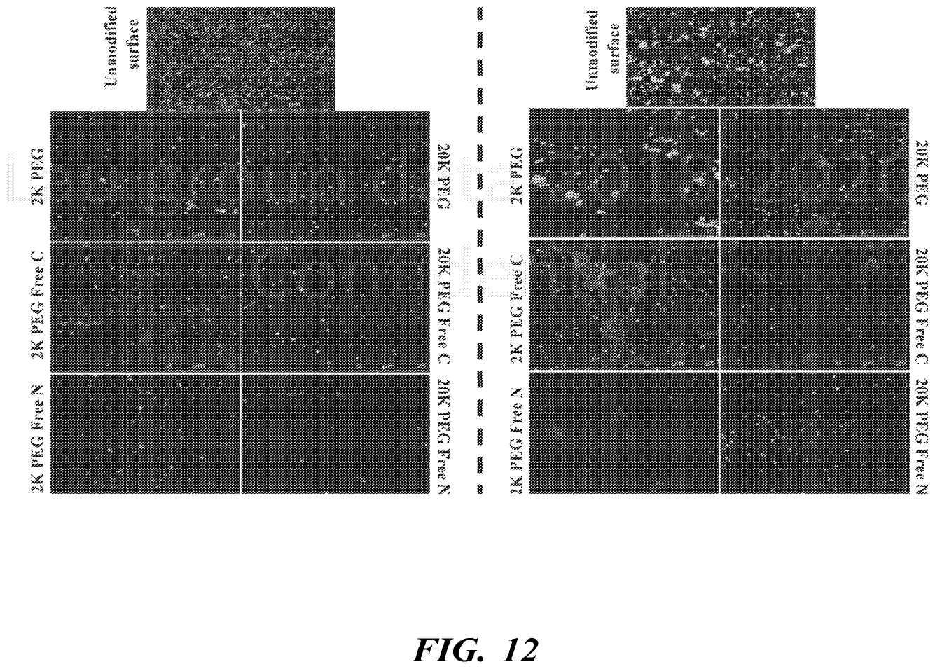

### DETAILED DESCRIPTION

In the present disclosure, we employ a 12-mer (Nlys-Nspe-Nspe)₄ antimicrobial peptoid with an amphiphilic helical structure, first reported by Barron et al., [11] as a model AMP mimic for investigating the influence of immobilization design on surface antimicrobial activity. We first tested the effects of modifying the peptoid's N- and C-termini with diethylene glycol segments on the minimum inhibitory concentrations (MICs) in solution. We then demonstrated the conversion of surface immobilized amines into azides for copper(I)-catalyzed alkyne-azide cycloaddition (CuAAC) surface coupling of the peptoid, with or without a 2 kDa polyethylene glycol (PEG) tether. We characterized the surface modification steps by water contact angle (WCA) analysis and X-ray photoelectron spectroscopy (XPS), and finally assayed the surfaces for protein adsorption and live/dead bacterial attachment. We hypothesized that sufficient spatial separation between AMPs and hence flexibility in molecular arrangement, such as enabled by a PEG tether, is required to both resist bacterial attachment and retain antimicrobial activity on a surface.

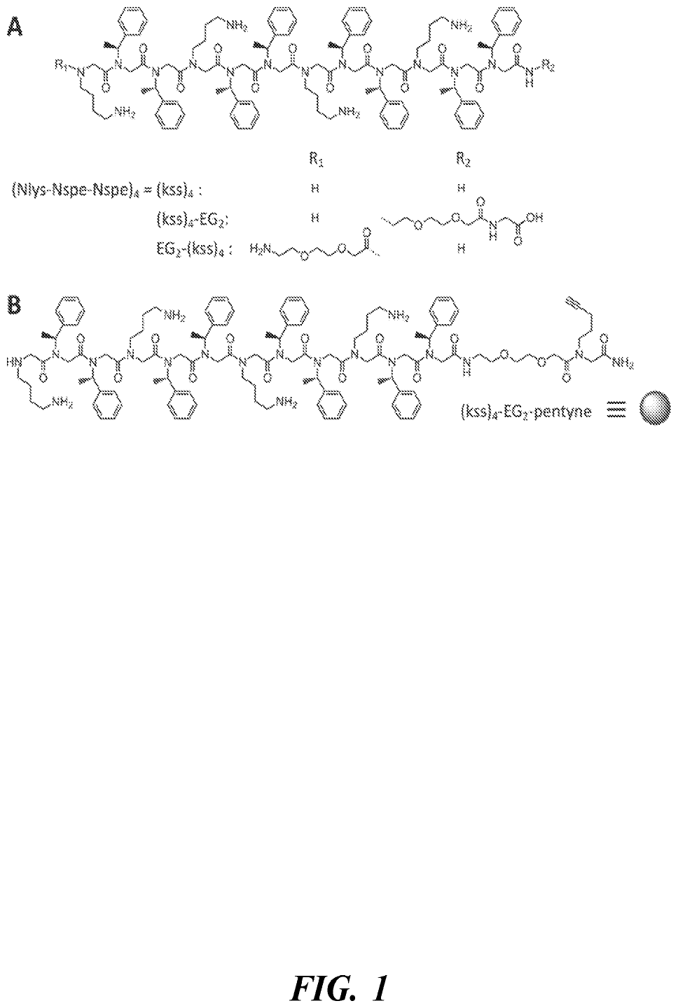

The (Nlys-Nspe-Nspe)4 parent sequence is composed of a repeating “kss” motif in which k and s are, respectively, the Lys analogue N-(4-aminobutyl)glycine (Nlys) and the a-chiral (S)—N-(1-phenylethyl)glycine (Nspe) (FIG. 1A). The sequence represents an archetypical ABB trimer motif in which A is cationic and B is hydrophobic (often Nspe to induce helicity). Peptoid synthesis was carried out using well-established “sub-monomer” solid phase synthesis (SSPS),[9b] and all sequence modifications were performed on-resin using commercially available building blocks (see ESI). HPLC and LC-MS characterization of purified sequences are shown in FIGS. S1 and S2.

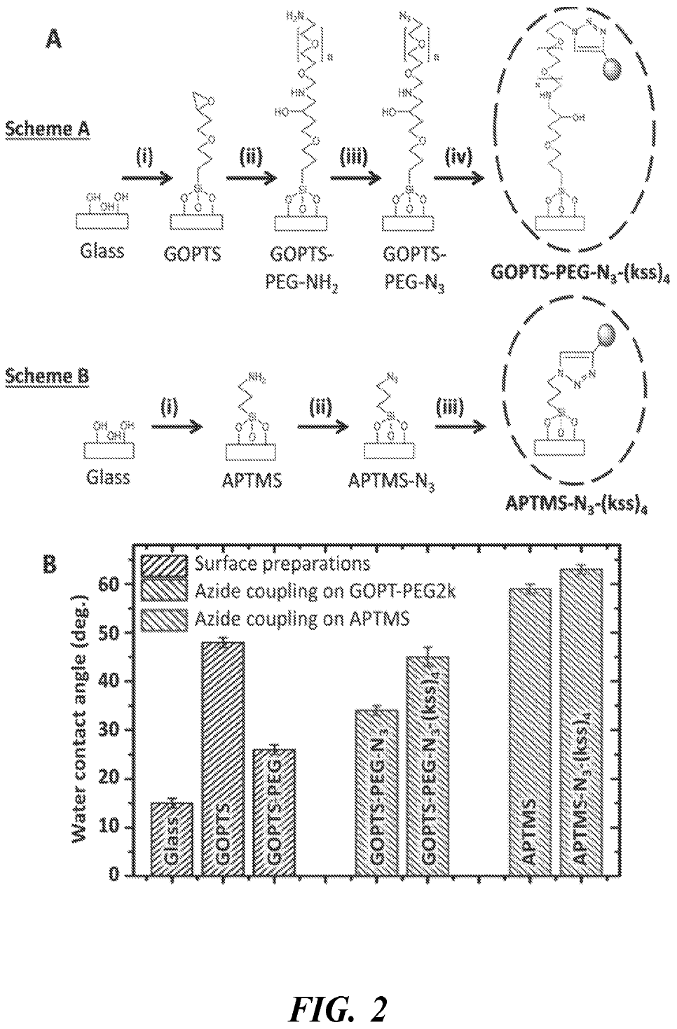

We first verified whether the C-terminal amide or the N-terminal amine of (kss)₄ might be important to its bactericidal effect. Cultured bacteria ((5×10⁷ CFU mL⁻¹)) were incubated in growth broth containing peptoids modified either at the C- or N-terminus with a diethylene glycol (EG₂) linker to give, respectively (kss)₄-EG₂ and EG₂-(kss)₄ (FIG. 1A). The EG₂ linker was also used later for spacing (kss)₄ from the surface-coupling group (see below). We found similar MICs with or without terminal modifications for the Gram negative and Gram positive strains tested (i.e. 16-20 mm against Pseudomonas aeruginosa (PA01), 5-9 mm against Escherichia coli (ATCC 25922), 1-6 mm against Staphylococcus aureus (NCTC 4135); see FIG. S3 for full data). A previous report modifying the N-terminus of (kss)₄ with a small-molecule metal chelator also showed little change in MIC against E. coli.[14] A different report modifying the C-terminus of a peptoid similar to (kss)₄ with a non-functional 20-residue peptoid lowered activity (i.e. increased MIC) by 2-10 times depending on the strain.[12] The overall data suggest that the peptoid N- and C-terminal structures are not essential to activity, but the steric bulk of the modification may be important. For surface immobilization, we further modified the C-terminal with a residue possessing a pentyne sidechain using regular peptoid SSPS to generate (kss)₄-EG₂-pentyne (FIG. 1B). In parallel, following established protocols (see ESI), we prepared glass slides silanized either with (3-glycidyloxypropyl)trimethoxysilane (GOPTS) further functionalized by a diamino-PEG₂ₖ, [15] or simply with (3-aminopropyl)trimethoxysilane (APTMS) (FIG. 2A). [16] The terminal amines on both surfaces were then converted to azides by one-step overnight incubation with imidazole-1-sulfonyl azide (see ESI). [17] This enabled CuAAC coupling[18] of (kss)₄-EG₂-pentyne to give peptoid functionalized surfaces with and without a PEG₂ₖ tether, that is, FIG. 2A Scheme A: GOPTS-PEG-N₃-(kss)₄ and Scheme B: APTMS-N₃-(kss)₄, respectively.

FIG. 2B shows water contact angle (WCA) data consistent with the expected changes in surface wettability after each modification step. For Scheme A, WCA increased with initial GOPTS modification (the organosilane is more hydrophobic than glass), and then decreased after coupling of diamino-PEG_{2K} (PEG-amine is hydrophilic). Subsequent conversion of the PEG terminal amine to a non-cationic azide (N₃) and then CuAAC coupling of (kss)₄, which possesses numerous hydrophobic Nspe groups, successively increased WCA. Similarly, for Scheme B, successive increases in WCA was observed after the glass was silanized with the organosilane APTMS and then finally functionalized with (kss)₄.

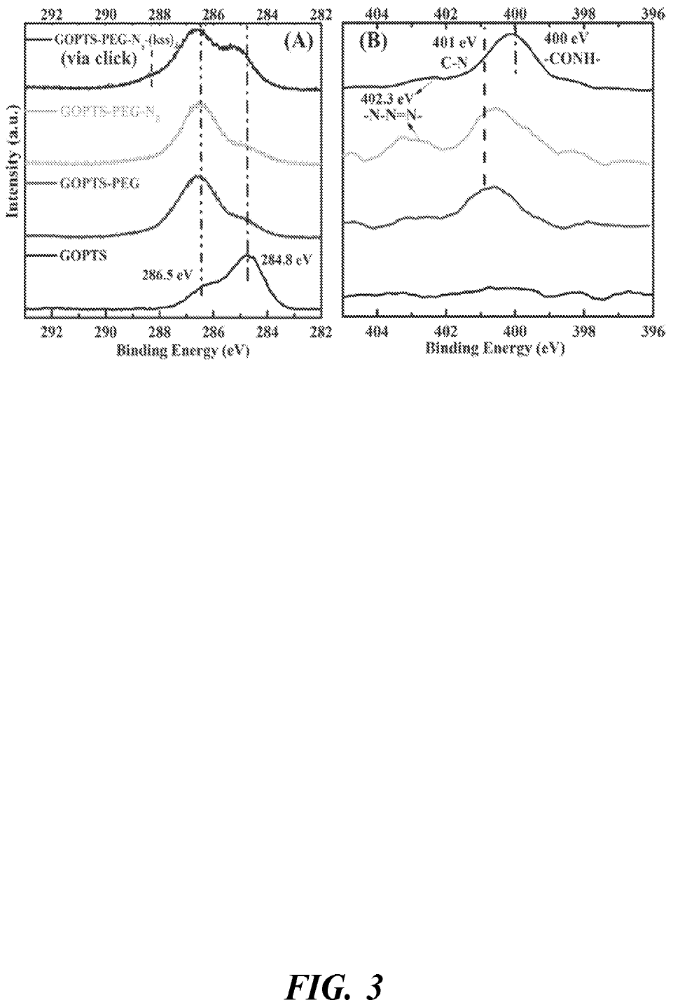

The surface modifications were further confirmed by XPS. In the C1s spectrum (FIG. 3A), a peak appeared at 286.5 eV after GOPTS silanization that indicated the expected addition of C—O bonds in the epoxide groups. PEG attachment was verified both by further increases of this C—O peak arising from the abundance of ether bonds in PEG, and by the appearance of the N1s N-C peak (401 eV) arising from the terminal amine of the PEG used (FIG. 3B). Subsequent azide derivatization was confirmed by the appearance of a N—N═N⁻ peak at 402.3 eV.[13, 19] Final peptoid coupling was confirmed by the substantial increase in peaks attributed to (kss)₄: C1s C—C (284.8 eV) and amide (288.3 eV),[19] and N1s N—C═O (399.5 eV) and NH₂ (400.8 eV).[20] By analyzing the attenuation of the Si2p signal from the SiO₂ substrate, we estimate a final peptoid surface density of 0.3 chain/nm² (Table S1 and related discussion).

Our PEG tether essentially forms a polymer brush, which should confer resistance against non-specific biomolecular adsorption and hence reduce bacterial attachment.[5a, c] For initial evaluation of this anti-fouling property, we incubated GOPTSPEG-N₃-(kss)₄ samples in 10% FBS (RT for 2 h). Following established protocol, [21] ellipsometry measurements showed little change of the adlayer thickness before and after incubation (FIG. S4: 3.5:0.6 nm vs. 3.7:0.5 nm, n=3), indicating little protein adsorption on the PEG-tethered peptoid surface.

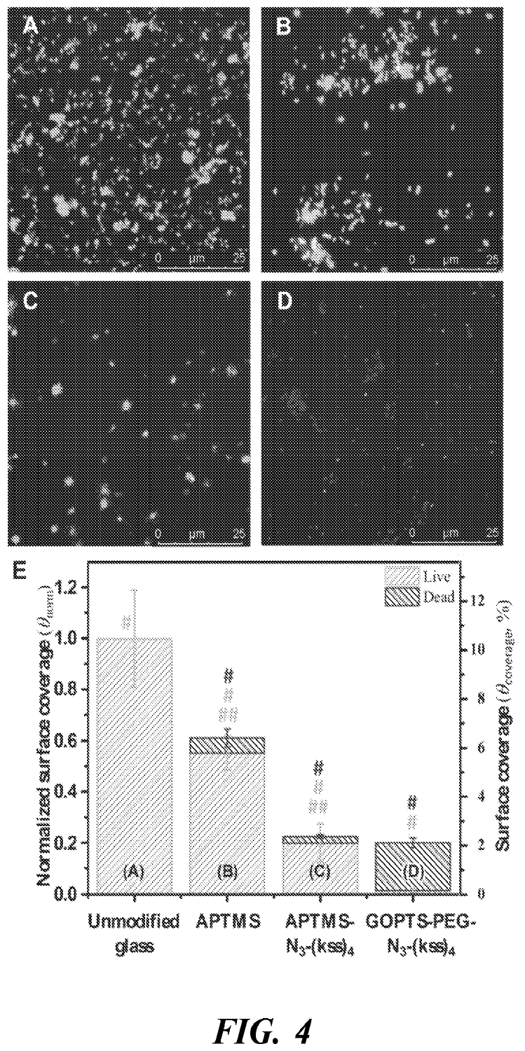

We then focused on evaluating the antimicrobial activity of the peptoid-functionalized surfaces against P. aeruginosa (PA01) due to its high relevance in HAI and risks associated with biofilm formation.[22] FIGS. 4A-D show typical images of attached live and dead/damaged bacterial cells stained, respectively by Syto 9 and propidium iodide (PI) after a 24 h attachment assay (5V107 CFUmL@1, 378C). FIG. 4E summarizes this data in terms of actual surface coverage (θ_{coverage}) and normalized coverage (θₙₒᵣₘ; relative to unmodified glass control).

On unmodified glass, a relatively high live P. aeruginosa θ_{coverage}=10.5% (θₙₒᵣₘ≡1) was observed, with only live bacteria found (FIG. 4A). In contrast, on PEG-tethered (kss)₄ (i.e. GOPTS-PEG-N₃-(kss)₄), a much lower θₙₒᵣₘ=0.21 was observed, of which only a small fraction consisted of live bacteria (θₙₒᵣₘ−live=0.02) (FIGS. 4D and E). In comparison, although a similar overall attachment (θₙₒᵣₘ₋ₜₒₜₐₗ=0.23) was observed on (kss)₄ immobilized without PEG (i.e., APTMS-N₃-(kss)₄), most of these cells were still live (θₙₒᵣₘ−live=0.20) (FIGS. 4C and E). Therefore, the 2 kDa PEG tether was instrumental to achieving high surface activity.

We performed a further control with APTMS modified glass, which gave an amine terminated surface (FIG. 2A, Scheme B, step [i]), to mimic the positive charge expected on (kss)₄ surfaces. FIGS. 4B and E show θ_{coverage}=6.5% on APTMS, consisting mostly of live bacteria. This level of attachment was moderately lower than the control (θₙₒᵣₘ=0.62), a phenomenon that has occasionally been observed on amino-silane surfaces (FIG. S5).[23] However, this was still about 3-times higher than on the (kss)₄ functionalized surfaces. This suggests a role of the antimicrobial sequence in suppressing attachment, notwithstanding its cationic nature, that might be related to the ability of similarly short surface-grafted peptoids in resisting biofouling.[21a, b] As for the minor fraction of dead/damaged attached cells (θ_{norm-dead}=0.06), a role for electrostatic surface adhesion that compromises the fluidity and integrity of bacterial membranes could be possible.

We had also performed our attachment assay against E. coli (ATCC 25922) but only very little attachment was observed and no statistically significant data were obtained. It is possible that some detachment had occurred under our conditions. Nonetheless, based on the even lower MIC measured for our modified peptoids against E. coli (and S. aureus) than P. aeruginosa (FIG. S3), we anticipate that GOPTS-PEG-N₃-(kss)₄ surface modification would be effective against these strains. Overall, the results for our PEG-tethered peptoid were characterized by low live bacterial attachment and a high proportion of dead/damaged cells. Our immobilized (lateral) density of 0.3 chain/nm2 (see XPS analysis), considered together with the flexibility in both lateral and vertical movement allowed by the 20 nm contour length of PEG N₃-(kss)₄, imply a maximum “volumetric” separation of about 5 nm between immobilized (kss)₄ sequences (see ESI for calculations). This is equivalent to the average molecular separation found in a 25 mm solution, which is orders of magnitude higher than the MICs of (kss)₄. Thus, surface immobilization can generate a very high local concentration of AMPs.

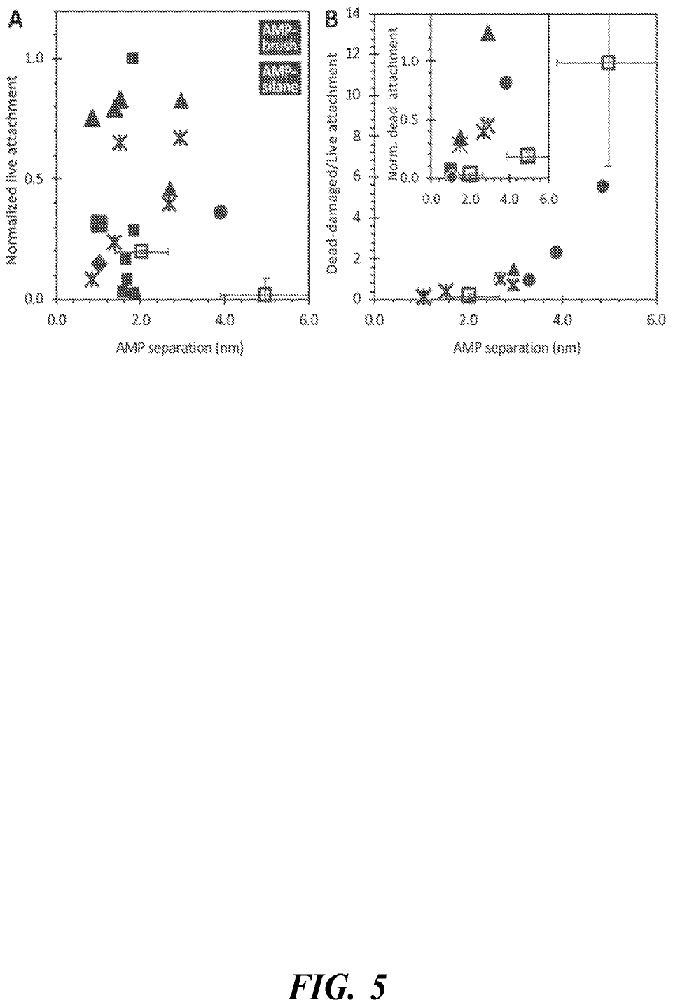

Indeed, past studies have focused on increasing the immobilized density of AMPs.[12, 23-25] However, AMPs generally possess hydrophobic and cationic groups, both of which promote undesirable bacterial attachment. Plotting our results alongside past studies, where data for calculating AMP separation are available (see ESI), shows many reports of high live attachments, especially those with relatively shorter AMP separations (i.e. high AMP densities) (FIG. 5A). Immobilization directly on silanized surfaces generally resulted in the shortest separations since silanization gives a high density of surface coupling groups. Tethering AMPs at the tip of polymer brushes, including our design, generally increased separations because the polymer chains prevent close packing and enable lateral and vertical movement around the anchor point of the polymer tether. However, some studies had attached multiple AMPs along the length of the polymer chains to increase immobilization density,[23b, 24] reducing AMP separation. Overall, FIG. 5A shows it is possible to decrease live attachment by increasing AMP separation, despite the diverse bacteria types and assay protocols surveyed. Moreover, our current design coupling a single AMP on PEG₂ₖ gave the lowest attachment at the largest AMP separation. This lowered fouling was corroborated by the low FBS adsorption observed (FIG. S6).

Turning to damaged/dead bacterial attachment, FIG. 5B inset shows that AMPs coupled at intermediate (3-4 nm) separations on brushes exhibited the highest apparent surface activity (i.e. highest dead attachments). This is consistent with our hypothesis that a polymer tether can introduce flexibility in molecular arrangement and orientation for enhanced membrane interactions. However, attached dead bacteria could still lead to biofilm formation as well as acute immune responses. FIG. 5B plots the same data ratioed against live attachment, to highlight cases with low overall attachment as well as relatively high activity. This reveals a remarkable correlation between increasing AMP separation and relative activity, despite the diverse experiments compared. In fact, whereas our APTMS-N₃-(kss)₄ design exhibited a low relative activity similar to other silane surfaces, our GOPTS-PEG-N₃-(kss)₄ brush design had the highest separation (5 nm) as well as the highest relative activity. Naturally, it can also be expected that the relative activity would decrease at very large AMP separations, which implies a very low density of AMPs insufficient for disrupting the membrane of a bacterium. An intermediate AMP separation should therefore exist for exhibiting an optimal relative activity.

In conclusion, we have shown that a model antimicrobial peptoid AMP mimic is amenable to modification of both its C and N-termini, and we demonstrated a one-step protocol for introducing azide-terminations on amino-functionalized surfaces for CuAAC “click” surface coupling. These demonstrations enabled a study of AMP immobilization design showing that surface activity is strongly enhanced by a polymer (PEG2k) tether, consistent with the importance of engineering spatial flexibility and vertical reach for suitable surface interactions with bacteria. Moreover, we introduce AMP separation as a new parameter for characterizing immobilized AMP anti-biofouling. This parameter highlights the very high local AMP concentrations achieved by surface immobilization. It also reveals, by comparison with literature data, a strong correlation between increasing AMP separation and increasing relative surface activity, indicated by a high proportion of dead/damaged bacteria among a low level of attachment. In fact, our PEG coupling design exhibited the largest AMP separation and also the highest relative activity. The present results therefore highlight the potential of optimizing AMP separation, rather than immobilization density, to enable both surface activity and reduced bacterial attachment.

In some embodiments of the products and methodologies disclosed herein, the treated, peptoid-containing surfaces may be derived from surfaces containing suitable functional groups. Such functional groups may contain oxygen, nitrogen, sulfur, phosphorous, boron, or metals. Such metals may include, for example, Mg, Li, Cu and Al. Examples of such functional groups may include, but are not limited to, hydroxyl, carbonyl, aldehyde, haloformyl, carbonate ester, carboxyl, carboalkoxyl, methoxy, hydroperoxy, peroxy, ether, hemiacetal, hemiketal, acetal, orthoester, methlenedioxy, orthocarbonate ester and carboxylic anhydride groups; carboxyamide, primary amine, secondary amine, tertiary amine, ammonium, primary ketimine, secondary ketimine, primary aldimine, secondary aldimine, imide, azide, azo, cyanate, isocyanate, nitrate, nitrile, isonitrile, nitrosooxy, nitro, nitroso, oxime, pyridyl and carbamate groups; sulfhydryl, sulfide, disulfide, sulfinyl, sulfonyl, sulfino, sulfo, thiocyanate, isothiocyanate, carbonothioyl, carbothioic S-acid, carbothioic O-acid, thiolester, thionoester, carbodithioic acid, and carbodithio groups; phosphino, phosphono and phosphate groups; borono, O-[bis(alkoxy)alkylboronyl], hydroxyborino and O-[alkoxydialkylboronyl] groups; alkyllithium, alkylmagnesium halide, alkylaluminum and silyl ether groups; alkenes and alkynes; and groups containing one or more radicals such as, for example, carboxylic acyl radicals.

In some embodiments of the products and methodologies disclosed herein, the treated, peptoid-containing surfaces may comprise two or more peptoids which may be distinct. For example, such surfaces may be derived by creating a surface containing a first tethered peptoid, and applying a second peptoid to the surface which bonds to the first peptoid covalently, ionically, through hydrogen bonding, or through van der Waals forces.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims. For convenience, some features of the claimed invention may be set forth separately in specific dependent or independent claims. However, it is to be understood that these features may be combined in various combinations and subcombinations without departing from the scope of the present disclosure. By way of example and not of limitation, the limitations of two or more dependent claims may be combined with each other without departing from the scope of the present disclosure.

### REFERENCES

[1] a) J. W. Costerton, P. S. Stewart, E. P. Greenberg, Science 1999, 284, 1318-1322; b) E. M. Hetrick, M. H. Schoenfisch, Chem. Soc. Rev. 2006, 35, 780-789; c) C. Desrousseaux, V. Sautou, S. Descamps, O. Traore, J. Hosp. Infect. 2013, 85, 87-93.
[2] a) R. Chmielewski, J. Frank, Compr. Rev. Food Sci. Food Saf. 2003, 2, 22-32; b) X. Z. Zhao, C. J. He, ACS Appl. Mater. Interfaces 2015, 7, 17947-17953; c) D. W. Wang, X. Wu, L. X. Long, X. B. Yuan, Q. H. Zhang, S. Z. Xue, S. M. Wen, C. H. Yan, J. M. Wang, W. Cong, Biofouling 2017, 33, 970-979.
[3] C. D. Nadell, K. Drescher, K. R. Foster, Nat. Rev. Microbiol. 2016, 14, 589.
[4] a) K. Bazaka, R. J. Crawford, E. P. Ivanova, Biotechnol. J. 2011, 6, 1103-1114; b) D. Perera-Costa, J. M. Bruque, M. L. Gonz#lez-Mart&n, A. C. Gjmez-Garc&a, V. Vadillo-Rodr&guez, Langmuir 2014, 30, 4633-4641; c) K. W. Kolewe, J. Zhu, N. R. Mako, S. S. Nonnenmann, J. D. Schiffman, ACS Appl. Mater. Interfaces 2018, 10, 2275-2281; d) A. Hasan, S. K. Pattanayek, L. M. Pandey, ACS Biomater. Sci. Eng. 2018, 4, 3224-3233.
[5] a) C. Blaszykowski, S. Sheikh, M. Thompson, Chem. Soc. Rev. 2012, 41, 5599-5612; b) A. D. White, A. K. Nowinski, W. Huang, A. J. Keefe, F. Sun, S. Jiang, Chem. Sci. 2012, 3, 3488-3494; c) S. Lowe, N. M. O'Brien-Simpson, L. A. Connal, Polym. Chem. 2015, 6, 198-212.
[6] a) F. Costa, I. F. Carvalho, R. C. Montelaro, P. Gomes, M. C. L. Martins, Acta Biomater. 2011, 7, 1431-1440; b) A. Andrea, N. Molchanova, H. Jenssen, Biomolecules 2018, 8, 27.
[7] S. R. Palumbi, Science 2001, 293, 1786-1790.
[8] a) N. Molchanova, P. R. Hansen, H. Franzyk, Molecules 2017, 22, 1430; b) M. Sieprawska-Lupa, P. Mydel, K. Krawczyk, K. Wjjcik, M. Puklo, B. Lupa, P. Suder, J. Silberring, M. Reed, J. Pohl, Antimicrob. Agents Chemother. 2004, 48, 4673-4679; c) M. Xiao, J. Jasensky, J. Gerszberg, J. Chen, J. Tian, T. Lin, T. Lu, J. Lahann, Z. Chen, Langmuir 2018, 34, 12889-12896.
[9] a) K. H. A. Lau, Biomater. Sci. 2014, 2, 627-633; b) A. S. Knight, E. Y. Zhou, M. B. Francis, R. N. Zuckermann, Adv. Mater. 2015, 27, 5665-5691.
[10] M. El Yaagoubi, K. M. Tewari, K. H. A. Lau in Self-assembling Biomaterials (Eds.: H. S. Azevedo, R. M. P. da Silva), Elsevier-Woodhead, Amsterdam, 2018, pp. 95-112.
[11] a) N. P. Chongsiriwatana, J. A. Patch, A. M. Czyzewski, M. T. Dohm, A. Ivankin, D. Gidalevitz, R. N. Zuckermann, A. E. Barron, Proc. Natl. Acad. Sci. USA 2008, 105, 2794-2799; b) J. A. Patch, A. E. Barron, J. Am. Chem. Soc. 2003, 125, 12092-12093.
[12] A. R. Statz, J. P. Park, N. P. Chongsiriwatana, A. E. Barron, P. B. Messersmith, Biofouling 2008, 24, 439-448.
[13] J. He, J. Chen, G. Hu, L. Wang, J. Zheng, J. Zhan, Y. Zhu, C. Zhong, X. Shi, S. Liu, J. Mater. Chem. B 2018, 6, 68-74.
[14] J. Seo, G. Ren, H. Liu, Z. Miao, M. Park, Y. Wang, T. M. Miller, A. E. Barron, Z. Cheng, Bioconjugate Chem. 2012, 23, 1069-1079.
[15] a) M. Zelzer, L. E. McNamara, D. J. Scurr, M. R. Alexander, M. J. Dalby, R. V. Ulijn, J. Mater. Chem. 2012, 22, 12229-12237; b) J. N. Roberts, J. K. Sahoo, L. E. McNamara, K. V. Burgess, J. Yang, E. V. Alakpa, H. J. Anderson, J. Hay, L. A. Turner, S. J. Yarwood, M. Zelzer, R. O. Oreffo, R. V. Ulijn, M. J. Dalby, ACS Nano 2016, 10, 6667-6679.
[16] U. Jonas, C. Kreger, J. Supramol. Chem. 2002, 2, 255-270.
[17] R. Chapman, K. A. Jolliffe, S. Perrier, Aust. J. Chem. 2010, 63, 1169-1172.
[18] V. V. Rostovtsev, L. G. Green, V. V. Fokin, K. B. Sharpless, Angew. Chem. Int. Ed. 2002, 41, 2596-2599; Angew. Chem. 2002, 114, 2708-2711.
[19] W. Lin, C. Junjian, C. Chengzhi, S. Lin, L. Sa, R. Li, W. Yingjun, J. Mater. Chem. B 2015, 3, 30-33.
[20] A. Gouget-Laemmel, J. Yang, M. Lodhi, A. Siriwardena, D. Aureau, R. Boukherroub, J.-N. Chazalviel, F. Ozanam, S. Szunerits, J. Phys. Chem. C 2013, 117, 368-375.
[21] a) K. H. A. Lau, C. Ren, S. H. Park, I. Szleifer, P. B. Messersmith, Langmuir 2012, 28, 2288-2298; b) K. H. A. Lau, C. Ren, T. S. Sileika, S. H. Park, I. Szleifer, P. B. Messersmith, Langmuir 2012, 28, 16099-16107; c) K. H. A. Lau, T. S. Sileika, S. H. Park, A. M. L. Sousa, P. Burch, I. Szleifer, P. B. Messersmith, Adv. Mater. Interfaces 2015, 2, 1400225.
[22] S. L. Percival, L. Suleman, C. Vuotto, G. Donelli, J. Med. Microbiol. 2015, 64, 323-334.
[23] a) M. Godoy-Gallardo, C. Mas-Moruno, M. C. Fern#ndez-Calderjn, C. P8rez-Giraldo, J. M. Manero, F. Albericio, F. J. Gil, D. Rodr&guez, Acta Biomater. 2014, 10, 3522-3534; b) M. Godoy-Gallardo, C. Mas-Moruno, K. Yu, J. M. Manero, F. J. Gil, J. N. Kizhakkedathu, D. Rodriguez, Biomacromolecules 2015, 16, 483-496; c) R. Chen, M. D. Willcox, K. K. K. Ho, D. Smyth, N. Kumar, Biomaterials 2016, 85, 142-151.
[24] G. Gao, D. Lange, K. Hilpert, J. Kindrachuk, Y. Zou, J. T. J. Cheng, M. Kazemzadeh-Narbat, K. Yu, R. Wang, S. K. Straus, D. E. Brooks, B. H. Chew, R. E. W. Hancock, J. N. Kizhakkedathu, Biomaterials 2011, 32, 3899-3909.
[25] M. Gabriel, K. Nazmi, E. C. Veerman, A. V. Nieuw Amerongen, A. Zentner, Bioconjugate Chem. 2006, 17, 548-550.

What is claimed is:

1. A treated surface, comprising:
a substrate; and
a first peptoid bound to said substrate by way of a linking group.

2. The treated surface of claim 1, wherein said linking group is an ethylene glycol linking group.

3. The treated surface of claim 1, wherein said linking group contains diethylene glycol segments.

4. The treated surface of claim 1, wherein said substrate is a glass substrate.

5. The treated surface of claim 1, wherein said linking group is an ethylene glycol linking group.

6. The treated surface of claim 1, wherein said linking group contains diethylene glycol segments.

7. The treated surface of claim 1, wherein said substrate is a glass substrate.

8. The treated surface of claim 1, wherein each of said plurality of functional groups contains oxygen.

9. The treated surface of claim 1, wherein each of said plurality of functional groups contains nitrogen.

10. The treated surface of claim 1, wherein each of said plurality of functional groups contains sulfur.

11. The treated surface of claim 1, wherein each of said plurality of functional groups contains phosphorous.

12. The treated surface of claim 1, wherein each of said plurality of functional groups contains boron.

13. The treated surface of claim 1, wherein each of said plurality of functional groups contains a metal.

14. The treated surface of claim 13, wherein the metal is selected from the group consisting of Mg, Li and Al.

15. The treated surface of claim 1, wherein each of said plurality of functional groups is a hydroxy group.

16. The treated surface of claim 1, wherein each of said plurality of functional groups is independently selected from the group consisting of hydroxyl, carbonyl, aldehyde, haloformyl, carbonate ester, carboxyl, carboalkoxyl, methoxy, hydroperoxy, peroxy, ether, hemiacetal, hemiketal, acetal, orthoester, methlenedioxy, orthocarbonate ester and carboxylic anhydride groups.

17. The treated surface of claim 1, wherein each of said plurality of functional groups is independently selected from the group consisting of carboxyamide, primary amine, secondary amine, tertiary amine, ammonium, primary ketimine, secondary ketimine, primary aldimine, secondary aldimine, imide, azide, azo, cyanate, isocyanate, nitrate, nitrile, isonitrile, nitrosooxy, nitro, nitroso, oxime, pyridyl and carbamate groups.

18. The treated surface of claim 1, wherein each of said plurality of functional groups is independently selected from the group consisting of sulfhydryl, sulfide, disulfide, sulfinyl, sulfonyl, sulfino, sulfo, thiocyanate, isothiocyanate, carbonothioyl, carbothioic S-acid, carbothioic O-acid, thiolester, thionoester, carbodithioic acid, and carbodithio groups.

19. The treated surface of claim 1, wherein each of said plurality of functional groups is independently selected from the group consisting of phosphino, phosphono and phosphate groups.

20. The treated surface of claim 1, wherein each of said plurality of functional groups is independently selected from the group consisting of borono, O-[bis(alkoxy)alkylboronyl], hydroxyborino and O-[alkoxydialkylboronyl] groups.

21. The treated surface of claim 1, wherein each of said plurality of functional groups is independently selected from the group consisting of alkyllithium, alkylmagnesium halide, alkylaluminum and silyl ether groups.

22. The treated surface of claim 1, wherein each of said plurality of functional groups is independently selected from the group consisting of alkenes and alkynes.

23. The treated surface of claim 1, wherein each of said plurality of functional groups is independently selected from the group consisting of groups containing a radical.

24. The treated surface of claim 23, wherein at least one of said plurality of functional groups is a carboxylic acyl radical.

25. The treated surface of claim 1, further comprising:
a second peptoid bound to said first peptoid by way of a bonding selected from the group consisting of ionic bonding, covalent bonding, hydrogen bonding and van der Waals forces.

26. The treated surface of claim 25, wherein said first and second peptoids are components of a micellar assembly.

27. The treated surface of claim 25, wherein said second peptoid is water soluble.

28. The treated surface of claim 1, further comprising multiple instances of said first peptoid bound to said surface by way of said linking group.

29. The treated surface of claim 28, wherein the mean minimum distance between adjacent ones of said multiple instances of said first peptoid is less than about 20 nm.

30. The treated surface of claim 28, wherein the mean minimum distance between adjacent ones of said multiple instances of said first peptoid is less than about 10 nm.

31. The treated surface of claim 28, wherein the mean minimum distance between adjacent ones of said multiple instances of said first peptoid is less than about 5 nm.

32. The treated surface of claim 28, wherein the mean minimum distance between adjacent ones of said multiple instances of said first peptoid is at least about 1 nm.

33. The treated surface of claim 28, wherein the mean minimum distance between adjacent ones of said multiple instances of said first peptoid is at least about 2 nm.

34. A method for treating a surface containing a plurality of functional groups, comprising:
reacting the plurality of functional groups with a linking group, thereby creating a surface containing a plurality of linking groups; and
binding a first peptoid to each of the plurality of linking groups, thereby obtaining a first treated surface.

35. The method of claim 34, wherein said linking group is an ethylene glycol linking group.

36. The method of claim 34, wherein said linking group contains diethylene glycol segments.

37. The method of claim 34, wherein said substrate is a glass substrate.

38. The method of claim 34, wherein each of said plurality of functional groups contains oxygen.

39. The method of claim 34, wherein each of said plurality of functional groups contains nitrogen.

40. The method of claim 34, wherein each of said plurality of functional groups contains sulfur.

41. The method of claim 34, wherein each of said plurality of functional groups contains phosphorous.

42. The method of claim 34, wherein each of said plurality of functional groups contains boron.

43. The method of claim 34, wherein each of said plurality of functional groups contains a metal.

44. The method of claim 43, wherein the metal is selected from the group consisting of Mg, Li and Al.

45. The method of claim 34, wherein each of said plurality of functional groups is a hydroxy group.

46. The method of claim 34, wherein each of said plurality of functional groups is independently selected from the group consisting of hydroxyl, carbonyl, aldehyde, haloformyl, carbonate ester, carboxyl, carboalkoxyl, methoxy, hydroperoxy, peroxy, ether, hemiacetal, hemiketal, acetal, orthoester, methlenedioxy, orthocarbonate ester and carboxylic anhydride groups.

47. The method of claim 34, wherein each of said plurality of functional groups is independently selected from the group consisting of carboxyamide, primary amine, secondary amine, tertiary amine, ammonium, primary ketimine, secondary ketimine, primary aldimine, secondary aldimine, imide, azide, azo, cyanate, isocyanate, nitrate, nitrile, isonitrile, nitrosooxy, nitro, nitroso, oxime, pyridyl and carbamate groups.

48. The method of claim 34, wherein each of said plurality of functional groups is independently selected from the group consisting of sulfhydryl, sulfide, disulfide, sulfinyl, sulfonyl, sulfino, sulfo, thiocyanate, isothiocyanate, carbonothioyl, carbothioic S-acid, carbothioic O-acid, thiolester, thionoester, carbodithioic acid, and carbodithio groups.

49. The method of claim 34, wherein each of said plurality of functional groups is independently selected from the group consisting of phosphino, phosphono and phosphate groups.

50. The method of claim 34, wherein each of said plurality of functional groups is independently selected from the group consisting of borono, O-[bis(alkoxy)alkylboronyl], hydroxyborino and O-[alkoxydialkylboronyl] groups.

51. The method of claim 34, wherein each of said plurality of functional groups is independently selected from the group consisting of alkyllithium, alkylmagnesium halide, alkylaluminum and silyl ether groups.

52. The method of claim 34, wherein each of said plurality of functional groups is independently selected from the group consisting of alkenes and alkynes.

53. The method of claim 34, wherein each of said plurality of functional groups is independently selected from the group consisting of groups containing a radical.

54. The method of claim 53, wherein at least one of said plurality of functional groups is a carboxylic acyl radical.

55. The method of claim 34, further comprising:
applying a second peptoid to the first treated surface, thereby obtaining a second treated surface.

56. The method of claim 55, wherein said second peptoid is bound to said first peptoid by way of a bonding selected from the group consisting of ionic bonding, covalent bonding, hydrogen bonding and van der Waals forces.

57. The method of claim 55, wherein said first and second peptoids are components of a micellar assembly.

58. The method of claim 55, wherein said second peptoid is water soluble.

59. The method of claim 34, wherein said first treated surface contains multiple instances of said first peptoid bound to said surface by way of said linking group.

60. The method of claim 59, wherein the mean minimum distance between adjacent ones of said multiple instances of said first peptoid is less than about 20 nm.

61. The method of claim 59, wherein the mean minimum distance between adjacent ones of said multiple instances of said first peptoid is less than about 10 nm.

62. The method of claim 59, wherein the mean minimum distance between adjacent ones of said multiple instances of said first peptoid is less than about 5 nm.

63. The method of claim 59, wherein the mean minimum distance between adjacent ones of said multiple instances of said first peptoid is at least about 1 nm.

64. The method of claim 59, wherein the mean minimum distance between adjacent ones of said multiple instances of said first peptoid is at least about 2 nm.
